(19) United States
(12) Patent Application Publication
(10) Pub. No.: US 2007/0031806 A1
(43) Pub. Date: Feb. 8, 2007

(54) LEARNER-CENTERED SYSTEM FOR COLLABORATIVE LEARNING

(76) Inventors: Kien Chung LAM, Singapore (SG); Yeut Leng Ada CHAN, Singapore (SG)

Correspondence Address: OSTROLENK FABER GERB & SOFFEN, 1180 AVENUE OF THE AMERICAS, NEW YORK, NY, 100368403, US

(21) Appl. No.: 11/461,508

(22) Filed: Aug. 1, 2006

(30) Foreign Application Priority Data
Aug. 2, 2005 (SG) 200504782-4

(51) Int. Cl. G09B 3/00; G09B 7/00

(52) U.S. Cl. 434/350; 434/362

(57) ABSTRACT

A learner-centered system for collaborative learning is provided that departs from traditional teacher-centric modes of teaching. The computer-based system is accessible by a community of users over an electronic communications network. A data storage device for storing data comprising items of teaching content and learner-initiated content is thus remotely accessible by the users. A set of collaborative dialogue tools is provided that is configured for learners to freely initiate and generate their own items of learner-initiated content in relation to items of teaching content for storage. The learners are allowed to generate one or more links between an item of learner-initiated content so stored and at least one item of teaching content through a linking mechanism of the system, thereby enhancing the learners' learning process.

### FIELD OF THE INVENTION

The invention relates to a virtual environment for computer-assisted learning over an electronic network, and in particular to a collaborative community-based virtual learning system wherein a number of users are able to access, share and contribute content.

### BACKGROUND AND PRIOR ART

Traditionally, formal learning of any subject has been confined to physical classroom environments. In such environments, such as in a lecture or tutorial, there is one teacher assigned to instruct and guide a group of students. For instance, in a lecture environment, one teacher will be talking in front of a class of students, while the students listen and take notes. Thereafter, the students are left to do further reading on the subject and to prepare for assignments or tests. In classroom-based tutorials or seminars led by a teacher, there is some interaction between the teacher and students when the teacher questions the students on relevant topics to test their knowledge and discusses the subject in greater depth with them. In both cases, learning is highly teacher-centric, since the teacher is expected to lead the students through each lesson. There is no more formal interaction between students after these tutorials, which may only occur once or twice a week for each subject. After these formal classroom lessons, students are generally left to study on their own. Any contact between individuals is made on an ad-hoc basis, and any advancement in knowledge resulting from such contact is often not shared with the rest of the class.

Teachers delivering knowledge in front of a class or lecture group has become the norm for efficiency and not pedagogical reasons. This is the inheritance of the industrial age, where instruction is standardized and mass-production is the goal. With the advent of the information age and the Internet, there has been a drive towards computer-assisted learning over networks, or what is commonly referred to as “e-learning”. The conventional e-learning system by and large support and propagate the current practice of teaching and learning in two ways. One of these ways is the use of synchronous “virtual classrooms” to try and replicate the physical classroom through a virtual environment so that teachers and lecturers can conduct teaching online. Centra Live1υ for Virtual Classes and Macromedia Breeze Live™ are two examples of these types of systems for e-learning that are quite popular among learning institutions. This form of e-learning is no different in terms of being teacher-centric and at best is only as good as being physically present in the classroom or lecture hall.

Another type of e-learning system focuses on teaching and learning as a matter of delivering and acquiring content and knowledge. These e-learning systems are generally asynchronous in nature and are dedicated to delivering content and tracking the access of such content. They have been widely popular, especially during the dot-com era, because they free up teaching time and make teaching even more efficient. They are often known as Course Management Systems or Learning Management Systems. Blackboard™ and WebCT™ are two examples of these types of systems for e-learning that are quite popular among learning institutions. Over time, some of these e-learning systems also included “virtual classrooms” as part of their offerings.

However, it is clear that such computer-assisted virtual environments are deficient in that they do little more than deliver teaching content through computers, while emphasizing traditional teacher-centric modes of learning. That is one reason why e-learning has not really lived up to its potential in enhancing learning. With regard to the teaching content, the instructor is the gatekeeper of knowledge, who feeds information to students. While there may be features like discussion forums that allow students to have discussions and shared folders for students to share files, these are teacher-directed and are not conceptually linked to the teaching content for reference purposes. Students are not allowed to initiate and generate additional content that is in turn linked back to the teaching content to build upon the students' knowledge. This lives well with the assumption that the teacher knows all, the role of the student being essentially passive.

There is a need for a more learner-centric learning system in the form of a virtual learning community that puts the emphasis on the communities of learners rather than concentrating too much emphasis on the teacher through undue reliance only on the input of the teacher during the learning process. This is increasingly evident as we progress from the industrial age to the information age in the 21^{st} century where higher-order thinking skills such as analysis, synthesis and evaluation and life skills such as communication and interpersonal skills to collaborate effectively in teams are critical. All these can be better achieved by empowering the learners to construct their own knowledge in the context of virtual learning communities as expounded in the sociocultural learning theory.

### SUMMARY OF THE INVENTION

It is thus an object of the invention to develop a system for learning in a virtual collaborative environment that focuses on the learner's learning process by encouraging the initiation of learner-generated content and more closely associating learner-initiated and teaching content.

According to a first aspect of the invention, there is provided a learner-centered system for collaborative learning that is accessible by a community of users over an electronic communications network, comprising: a data storage device for storing data comprising items of teaching content and learner-initiated content; a set of collaborative dialogue tools configured for learners to freely initiate and generate their own items of learner-initiated content in relation to items of teaching content for storage; and a linking mechanism operative to enable learners to generate one or more links between an item of learner-initiated content so stored and at least one item of teaching content.

According to a second aspect of the invention, there is provided a learner-centered method for collaborative learning, comprising the steps of: providing a data storage device for storing data comprising items of teaching content and learner-initiated content, and configuring the data storage device such that said data is accessible by a community of users over an electronic communications network; enabling learners to freely initiate and generate their own items of learner-initiated content in relation to items of teaching content for storage; and generating one or more links between an item of learner-initiated content so stored and at least one item of teaching content at the option of the learners.

It would be convenient hereinafter to describe the invention in greater detail by reference to the accompanying drawings which illustrate one embodiment of the invention. The particularity of the drawings and the related description is not to be understood as superseding the generality of the broad identification of the invention as defined by the claims.

### BRIEF DESCRIPTION OF THE DRAWINGS

An example of a preferred embodiment of the system in accordance with the invention will now be described with reference to the accompanying diagrams and drawings, in which:

FIG. 1 is block diagram illustrating an environmental set-up of a networked system according to one implementation of the preferred embodiment of the invention;

FIG. 2 is a schematic general overview showing teaching content and learner-initiated content of a community that are accessible on the system;

FIG. 3 is a block diagram showing organic relationships between learner-initiated content and teaching content in the system;

FIG. 4 is a block representation of a preferred linking process;

FIG. 5 is a block diagram demonstrating an organic generation of learner-initiated content and links to corresponding teaching content;

FIGS. 6(a), 6(b) and 6(c) are block diagrams illustrating access by learners and teachers to the system, and exemplary interactions between them;

FIG. 7 is a block diagram showing exemplary activities that a learner may engage in the system;

FIG. 8 is a block diagram showing exemplary activities that a teacher may engage in the system;

FIG. 9 is an exemplary screenshot illustrating the listing of conversation and blog entries of the system in accordance with the preferred embodiment of the invention;

FIG. 10 is an exemplary screenshot illustrating the creation of links between teaching content and learner-initiated content; and

FIG. 11 is an exemplary screenshot illustrating collaborative writing and file sharing spaces made available under a conversation module according to the preferred embodiment of the invention.

### DETAILED DESCRIPTION OF THE PREFERRED EMBODIMENT OF THE INVENTION

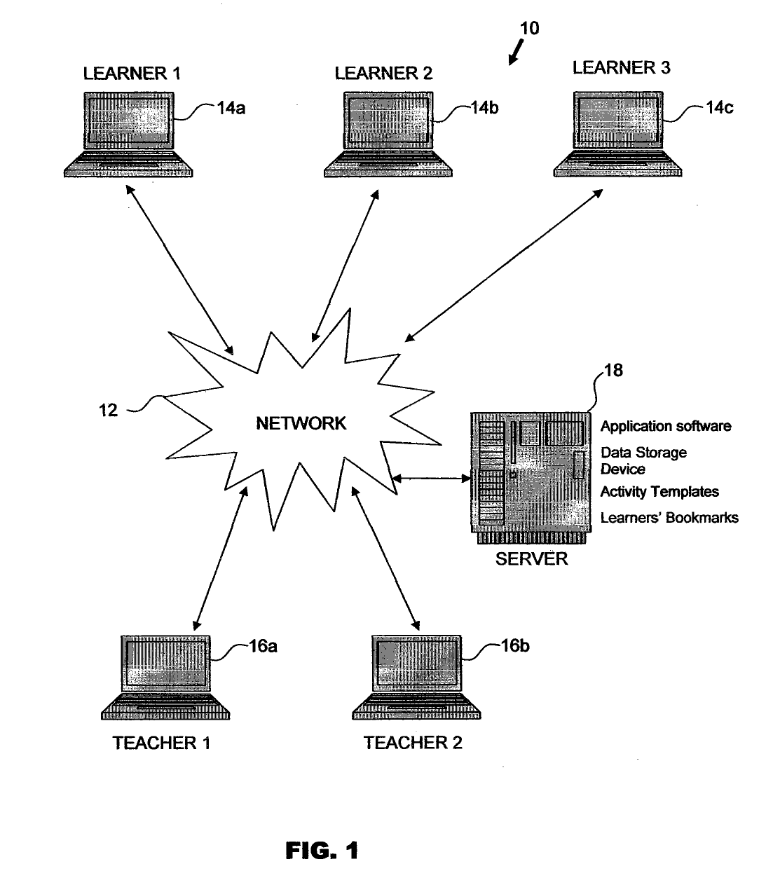

FIG. 1 is block diagram illustrating an environmental set-up of a networked system 10 for learner-centered collaborative learning according to one implementation of the preferred embodiment of the invention. The system 10 is accessible by one or more communities of users through an electronic communications network 12, which is typically a Local Area Network, the Internet or World Wide Web. Any other type of network that is set up for electronic communications is possible. A group of users, which may comprise one or more learners 14a, 14b, 14c and teachers 16a, 16b, are able to access a server computer 18 through the network 12. In this way, the learners 14 and teachers 16 may access the server computer 18 for learning and collaboration even though they are physically not at the same place. Learners 14 may be defined broadly as persons who access the system primarily to gain knowledge or understanding of a skill (such as students). Teachers may be defined broadly as persons whose role is to impart knowledge to or guide the learners (such as instructors). The server computer 18 has various modules such as application software, a storage device for storing and maintaining a database and archived information, activity templates for preparation of lessons and learners' bookmarks for linking information. The server computer 18 may comprise just one computer or a plurality of computers connected to the network. Nevertheless, the server computer 18 should be able to support use by a plurality of users simultaneously.

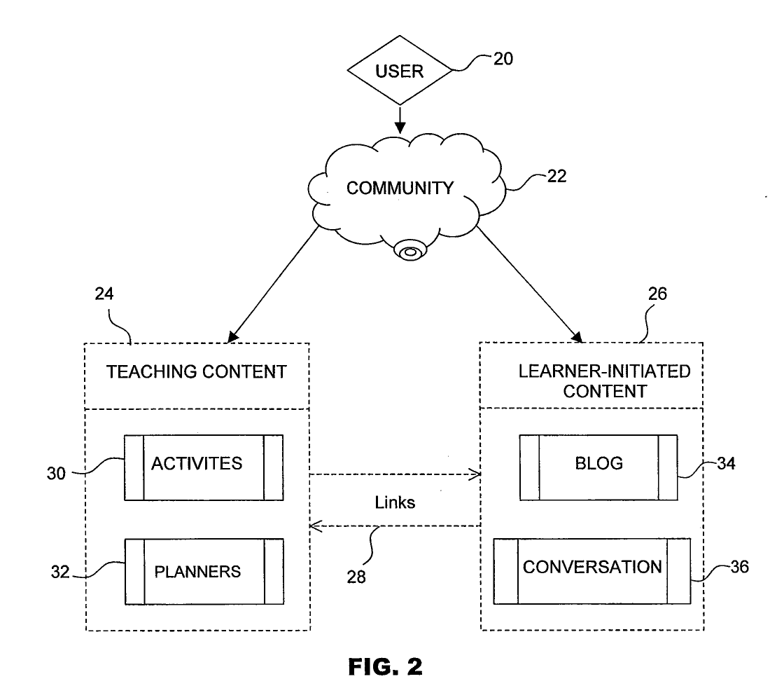

FIG. 2 is a schematic general overview showing teaching content 24 and learner-initiated content 26 on a community 22 that are accessible on the system 10. The term “community” refers to a group of users that is notionally gathered in the system for a particular purpose, such as to attend a certain course. Therefore, a group of users 20 who are learning the same subject may be part of the same community 22. The server computer 18 may be designed to host a number of different communities.

Typically, a user 20 would be given a user identification name and password to access the community 22 after registration to join the community 22. Once the user 20 successfully accesses the community, he is able to access teaching content 24 and learner-initiated content 26. Generally, teaching content” would refer to the content created by a teacher 16 that a learner 14 relies on to learn more about a subject, engage in problem-solving or other activities designed by the teacher 16. Teaching content 24 is used by a teacher to impart knowledge or guide learners, and may include, without limitation, modules such as activities 30 and planners 32. Other than these modules, reference material such as flash-based illustrations, read-only documents and presentations (not shown) may also be included under teaching content 24 and be accessible by the user 20.

In addition to teaching content, a primary advantage of the system lies in the fact that a learner may also create as well as access learner-initiated content 26 relevant to the subject. “Learner-initiated content”, as its name implies, would refer to content separate from the teaching content that is initiated and propagated by a learner. It would generally be inspired by but not necessarily prompted by a teacher or teaching content. Such content may be initiated and generated by learners 14 independently of the teachers 16, but would preferably relate to an item of teaching content 24. Learner-initiated content 26 may be created by any form of collaborative dialogue tools, such as conversation 36 tools and web-based publication tools. An example of a web-based publication tool would be a blog 34.

Blogs 34 allow users 20, typically learners 14, to reflect on what they have studied, and put forth their own thoughts, views or comments. Conversations 36 allow a group of users 20 to communicate with one another through a chat program and chatting may be carried out synchronously or asynchronously. Learner-initiated content 26 as described in the preferred embodiment of the invention is different from the approach of the prior art, as these may be generated by a learner 14 without prompting or pursuant to a specific request by the teacher 16. It can be done totally at the discretion of the learner 14. Data comprising teaching content and learner-generated content is stored in the data storage device comprised in the server computer 18.

Another innovation of the system is that items of learner-initiated content 26 are linked to items of teaching content 24 using links 28. A linking mechanism is operative to generate links 28 between an item of learner-initiated content 26 that is stored by a learner 14 and at least one item of teaching content 24. These links 28 are preferably bidirectional, such that each link comprises a primary link from an item of learner-initiated content 26 to an item of teaching content 24, and a reverse link in an opposite direction. A navigation interface associated with the system 10 is adapted to access corresponding bidirectionally-linked items of teaching content 24 and learner-initiated content 26 by tracking such links 28. Therefore, any content from the learner-initiated content 26 is automatically referable to specific teaching content 24, such as a chapter or a page concerning a certain topic, and conversely, a user 20 may refer to and access learner-initiated content 26 generated by other users when the user reads such chapter or page from the teaching content 24. Therefore, the benefit is that a learner would not only be able to learn from teaching content 24, but also learner-initiated content 26 contributed by other users.

Learners can freely initiate blogs 34 to reflect on their learning journey. Each learner can have as many blog entries 34 as he desires, and all of these can be listed chronologically. A teacher or a fellow learner may include one or more feedback comments 35 for each blog entry, which are received and stored in the storage device. It is useful to allow everyone in the same learning community 22 to read all the blog entries 34 and comments 35. The dialogue tool may further comprise a personal workspace for storing users' entries in the form of blogs 34. Learners can select from their blog entries 34 to include them in their personal online portfolios.

To facilitate linking, learners 14 can easily link their blog entries 34 to the teaching content 24 through a single click bookmark function. Related blogs 34 that are bookmarked to teaching content 24 are listed to facilitate track-back referencing. Any new blog entry 34, new comments 35 or amendments may trigger a personalized alert for each learner.

Furthermore, learners 14 can freely initiate conversations to discuss any topic of interest relating to the teaching content 24. Learners 14 can select and add members (both online and offline) to participate in conversations 36 at any point of time. A user can post messages to a conversation 36 even though he is the only person online and users who are offline will be able to read the messages and add to the conversation when they come online.

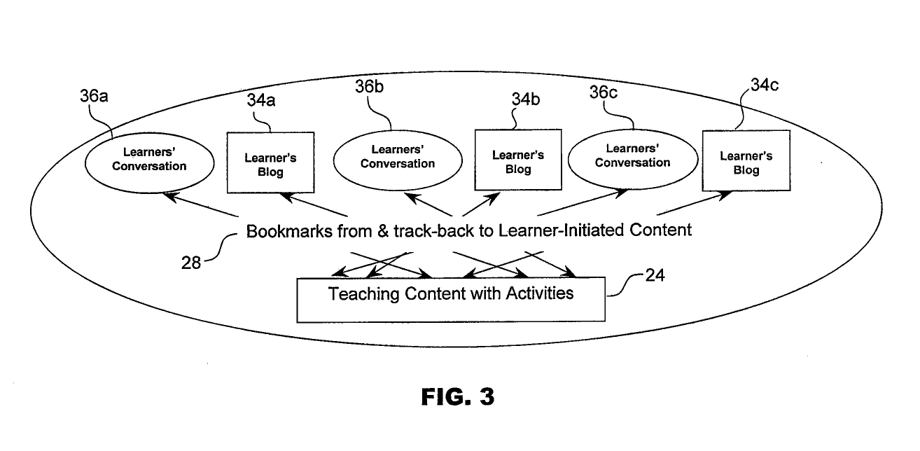

FIG. 3 is a block diagram showing organic relationships between learner-initiated content 26 and teaching content 24 in the system. Here, a number of separate items of learner-initiated content are created, for example learners' blogs 34a, 34b, 34c, and learners' conversations 36a, 36b, 36c. All these blog entries and conversations are each individually linked to a location in the teaching content 24 by way of links 28. They may link to the same location, or to different locations in the teaching content 24. Besides linking learner-initiated content 26 to teaching content 24, the links 28 also link teaching content 24 in the opposite direction to each of the individual learners' blog entries 34a, 34b, 34c and learners' conversations 36a, 36b, 36c.

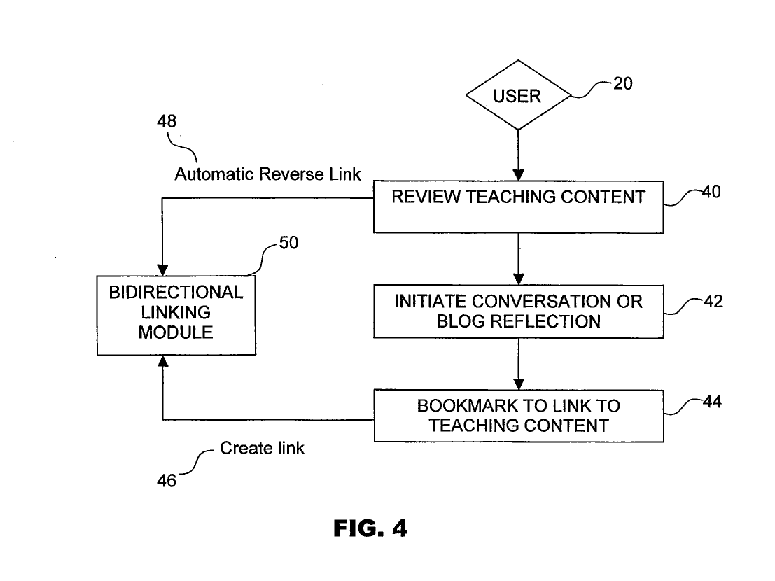

FIG. 4 is a block representation of a preferred linking process. A user 20 who has joined a community reviews teaching content that is available 40. If he desires to do so, he initiates a conversation with another user or posts his reflections on a blog 42. As he does so, he may choose to link his conversation or blog to a specific location of the teaching content 44 using the bookmarking feature. The system will then create a link to the particular item of teaching content 46 and also automatically create a reverse link 48 from the teaching content to the conversation or blog. A bidirectional linking mechanism 50 saves these links to facilitate access by a user to the information in the corresponding teaching and learner-initiated content.

Instead of requiring a user 20 to bookmark an item of learner-initiated content 26 to teaching content 24, the system may also offer an option of executing the linking automatically. This can be done, for example, if the user 20 generates some learner-initiated content 26 while going through an item of teaching content 24. The system may create a link between these items of teaching content 24 and learner-initiated content 26 automatically once the latter is stored. Nevertheless, for more control by a user 20, a higher level of user-intervention in the linking and bookmarking process would be preferable.

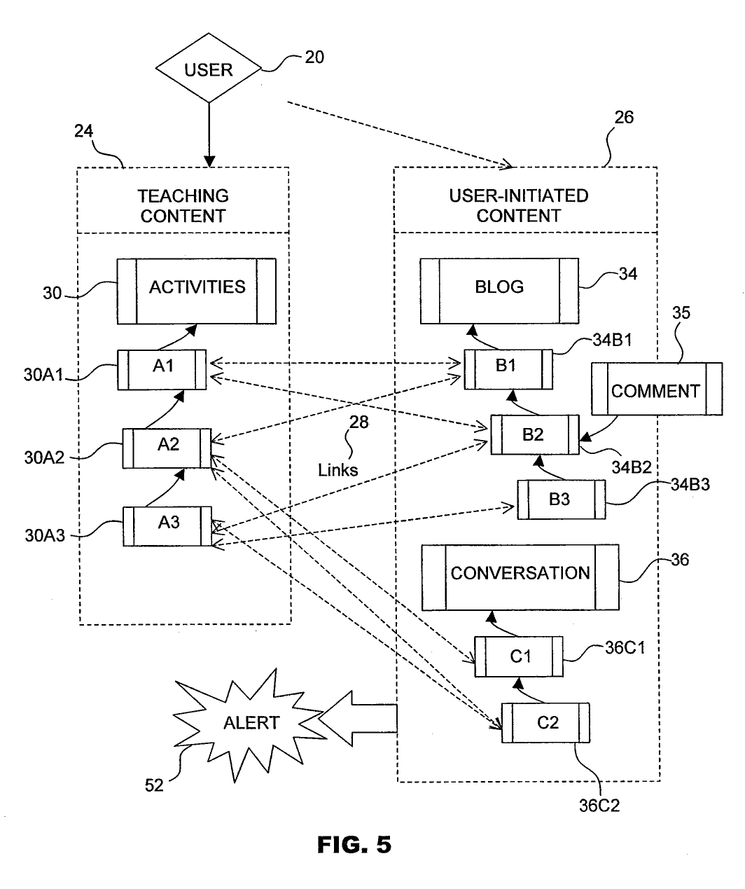

FIG. 5 is a block diagram demonstrating an organic generation of learner-initiated content 26 and links to corresponding teaching content 24. A user 20 accesses a community 22 and participates in activities 30 offered by the teaching content 24. As he participates in the activities 30, separate activity sub-modules 30A1, 30A2, 30A3 are created. While participating in the activities 30, he may concurrently also wish to create blogs or conversations relevant to the topic, or he may do so later.

In FIG. 5, the user 20 has created separate blogs 34B1, 34B2, 34B3, and he is able to create links 28 with respect to them. He may choose to bookmark 34B1 to link to 30A1 and 30A2, 34B2 to link to 30A1 and 30A3, and 34B3 to link to 30A3. The user 20 has also created separate conversations 36C1, 36C2. He has chosen to bookmark 36C1 to link to 30A2, and 36C2 to link to 30A2 and 30A3. Accordingly, when the user 20 or others access the teaching content 24 later, when they are reading an activity 30A1, they may immediately access blogs 34B1 and 34B2 which have been generated by learners 14 that are relevant to this activity. Furthermore, when reading the blog 34B2, the user 20 may also cross-reference another activity 30A3. This activity 30A3 is also relevant to the subject-matter of activity 30A1, and these activities are linked via blog 34B2. Thus, all users 20 in the community may initiate and share information, thoughts and views in relation to all items of the teaching content 24.

Moreover, the system is designed such that one or more comments 35 comprising feedback from learners 14 and teachers 16 can be created to refer to items of learner-initiated content 26. In FIG. 5, a comment 35 is added to the blog 34B2. Such a comment 35 may be added by either a learner 14 or teacher 16. It is also possible that users 20 may be interested to know once a new item of user-initiated content 26 has been added. A customizable alert module for alerting a user as to the entry of a new item of learner-initiated content 26 serves this function. Whenever there is any new message, file attachment or content posted to learner-initiated content 26, the system is programmable to send out a personalized alert 52 to such users 20 who have chosen to be alerted of such events. Alerts 52 may be user-configurable so that one is able to choose, for instance, what alerts to receive.

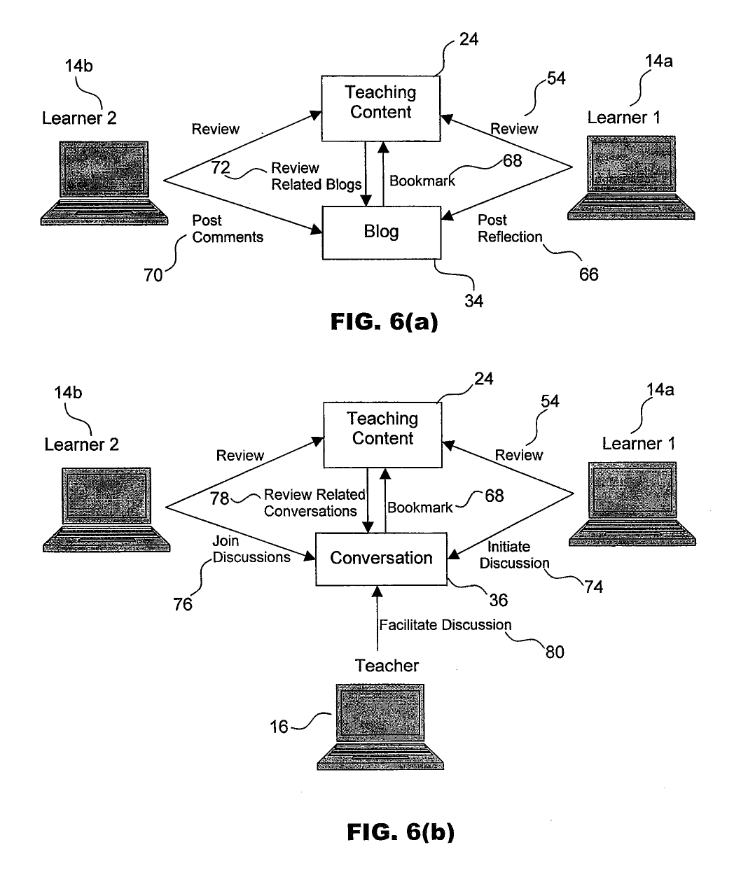

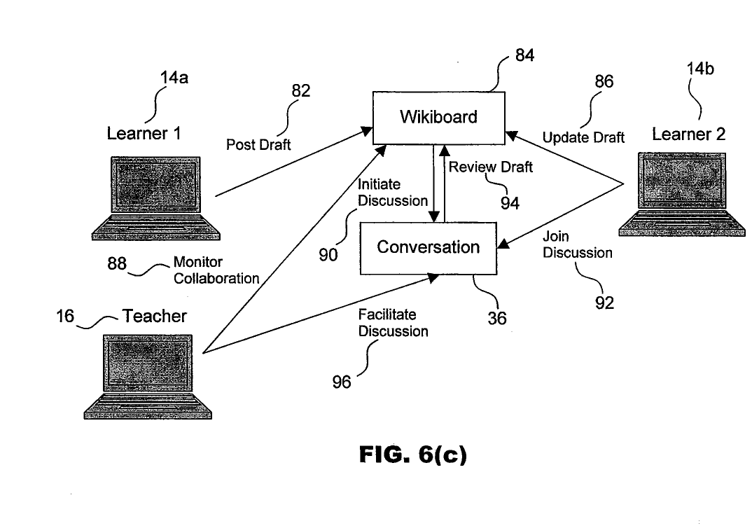

FIGS. 6(a), 6(b) and 6(c) are block diagrams illustrating access by learners 14 and teachers 16 to the system 10, and exemplary interactions between them. In FIG. 6(a), the same teaching content 24 is notionally accessed by two learners 14a, 14b. The first learner has reviewed the teaching content 54, and decides to post his own reflections 66. He creates an entry into the blog 34 and bookmarks 68 to link it to an item of teaching content 24. The item of teaching content 24 in turn tracks and refers back to the blog entry 34.

The second learner 14b reviews the same item of teaching content 24. He notes that there is learner-initiated content relating to this teaching content 24 and decides to review related blogs 72, including the first learner's blog entry 34. After reviewing the blog entry, the second learner decides to post a comment relating to the blog entry 70. The teaching content 24, related blog 34 and comments 35 are all linked and accessible by other users.

FIG. 6(b) shows another example involving a conversation module 36. The first learner 14a has reviewed 54 the teaching content 24 and decides to initiate a discussion on the topic 74. He bookmarks 68 the discussion to link it to an item of teaching content 24. The item of teaching content 24 in turn tracks back to the conversation 36.

The second learner 14b, who has reviewed the same teaching content 24 wants to review related conversations 78. He notes the conversation 36 that the first learner has initiated and decides to join in the discussion 76. A teacher 16 in the same community 22 accessing the system has also noted the ongoing conversation 36 and decides to join in the conversation to facilitate the discussion 80. All the conversations are referable to the item of teaching content 24 that the first learner 14a has linked them to. Accordingly, any other user 20 who enters the system later may choose to join in the discussion. Otherwise, he may simply read through what has been discussed and learn from that.

FIG. 6(c) shows an example of collaboration involving the use of a conversation module 36 together with a collaborative writing tool, preferably in the form of a Wikiboard 84. The first learner 14a has posted a draft statement onto the Wikiboard for the purpose of collaboration 82. The second learner 14b notes the posting and updates the draft as he deems necessary 86. The teacher 16 may at this point passively monitor the collaboration 88 or may decide to participate in it. The first learner 14a may initiate a discussion 90 on the conversation module 36. The second learner 14b joins the discussion 92.

In the conversation module 36, the first learner 14a and second learner 14b may review the draft together 94, and they may further update the Wikiboard 84 during the discussion. During the discussion, the teacher 16 may also participate to facilitate the discussion 96, although this is optional.

As mentioned above, it is not necessary that all the activities above take place synchronously. More often than not, they will take place asynchronously if the participants are not logged into the system at the same time. The system is configured to store conversation transcripts for retrieval such that participants who are not online when any entry is posted to a conversation transcript may read the entry and add to the conversation transcript when they are online. This is advantageous because it enables users 20 in different time zones or who otherwise are unable to log into the community at the same time to nevertheless collaborate with other users 20 asynchronously.

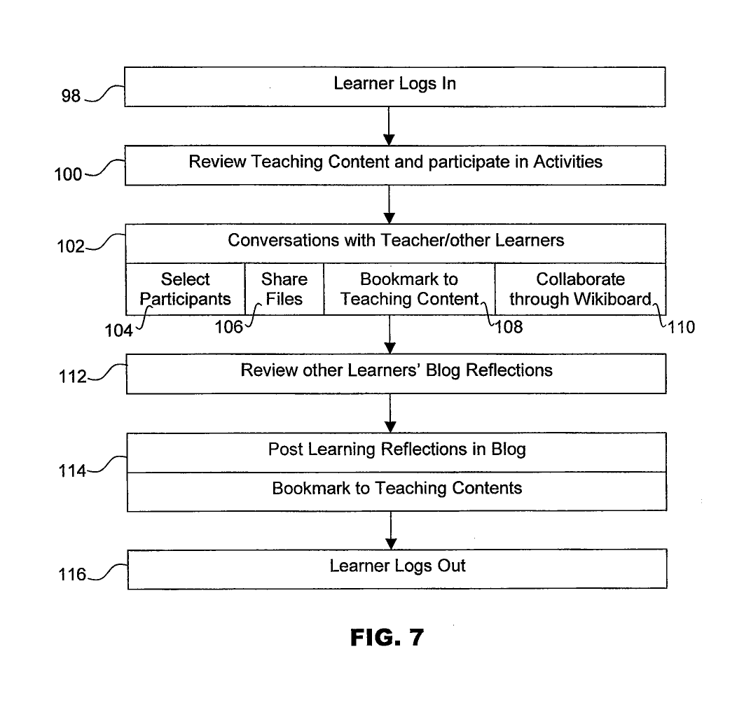

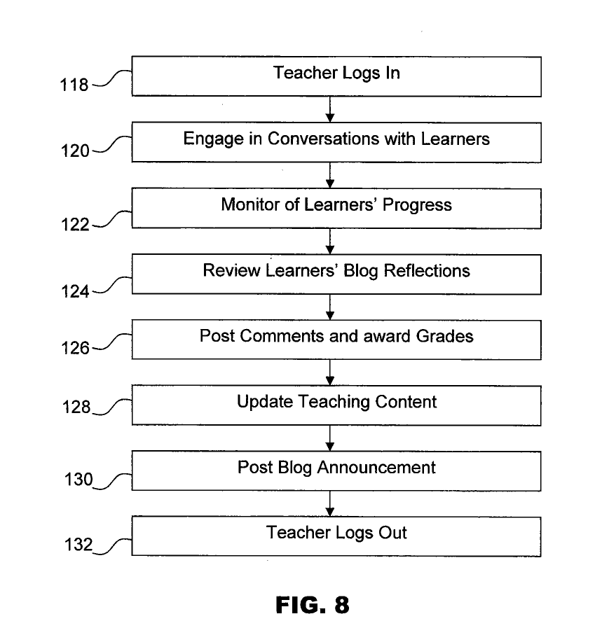

FIG. 7 is a block diagram showing exemplary activities that a learner 14 may engage in the system 10. The learner logs into the community 98. He then reviews the teaching content that is available to him and participates in activites set up by the teacher 100. Whenever necessary, he may initiate or join in conversations with the teacher(s) or other learner(s) 102. To initiate a conversation, he may first select the participants 104. He may also designate files to share 106, such as by uploading these files to the server computer. Whether he is initiating or joining a conversation, he may choose to bookmark the conversation to link it to teaching content 108. An additional function that is collateral to the conversation module is that he may also collaborate with other users through a Wikiboard 110.

The user may also review other learners' blog reflections 112 or post his own reflections in a blog 114 to share knowledge. The blog(s) are preferably bookmarked to teaching content. At any time when a learner has finished a session, he may log out 116.

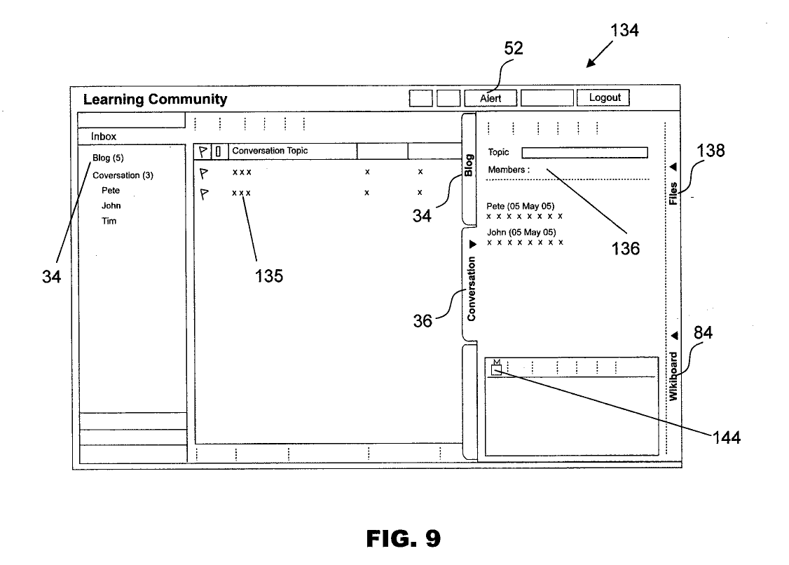

FIG. 8 is a block diagram showing exemplary activities that a teacher 16 may engage in the system 10. The teacher logs into the community 118. If he sees that there are ongoing conversations that he may contribute, he may engage in conversations with learners 120. Otherwise, he can monitor learners' progress 122 through their participation in activities or tests in the teaching content, or through the learner-initiated content by reading their blogs or conversations.

Separately, the teacher may review learners' blog reflections 124 and post comments and award grades 126. If there is a need, the teacher can also update teaching content 128, such as by uploading new content files. In addition, the teacher may decide to post a blog announcement 130 to inform the learners about updated teaching content, learners' grades, and so on. When the teacher has finished, he may log out 132.

FIG. 9 is an exemplary screenshot extracted from a display device 134 illustrating the listing of conversation and blog entries of the system 10 in accordance with the preferred embodiment of the invention. The navigation interface of the system is configured to list items of learner-initiated content 26 that is sortable to facilitate searching. In the middle of the screen, a list of conversations 135 is set out. Alternatively, if the user clicks on “Blog” 34 on the left of the screen, a list of blogs will be set out. Preferably, the list of conversations 135 is initially arranged chronologically, but the user may choose other arrangements that he desires for the purpose of sorting.

Each conversation has its own file sharing space as well as a space for a collaborative writing tool referred to herein as the Wikiboard 84 for collaborative creation and editing of learner-initiated content both synchronously and asynchronously. Members involved in the conversation may edit the contents of documents as they see fit, allowing the document to be continually improved. The system will also log any updates to the files 138 by the learners 14 in transcripts of the conversation 36.

All conversations are listed just like conventional emails in chronological order for easy access with support for sorting. For each item of conversation from the list of conversations 135, a list of members 136 involved in the conversation will be shown. A learner 14 is allowed to select any member of the community to participate in an online conversation. To make it easy to find out whether a message has been read, a pre-programmed status indicator is used for indicating whether an item of learner-initiated content 26 has been read. Accordingly, the names of members that have not read the latest entry may be indicated or highlighted, such as by fading the characters of the name or by using different pre-configured colors.

There are tabs on the right of the screen linking to “Blog” 34, “Conversation” 36, “Wikiboard” 84 and “Files” 138 relating to such item of conversation. Clicking on any conversation in the list in the middle of the screen will cause the contents of the relevant conversation to be shown in the panel area that will slide out at the right of the screen. This feature is also applicable to the listing of blogs.

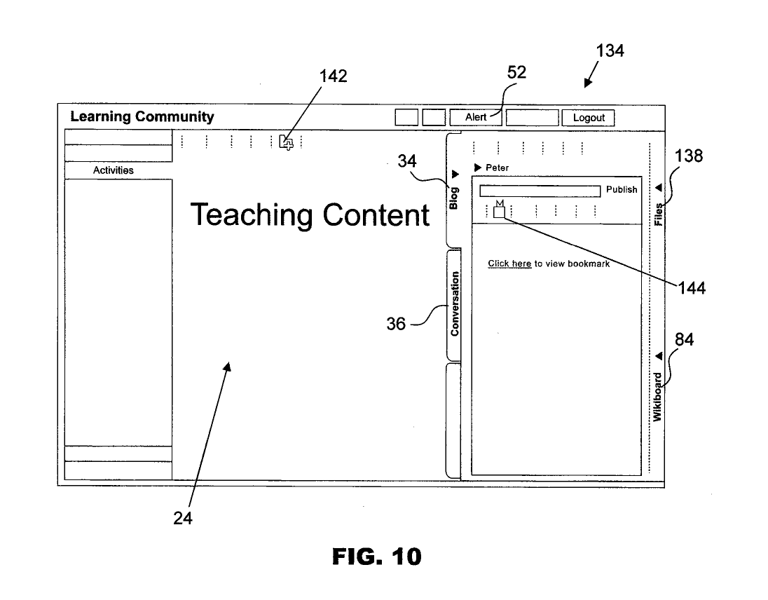

FIG. 10 is an exemplary screenshot illustrating the creation of links between teaching content 24 and learner-initiated content 26. The display device 134 is configured to display teaching content 24 and learner-initiated content 26 adjacent to each other. When teaching content 24 is accessed, it is possible to prepare a blog 34 to the right of teaching content 24, as shown in FIG. 10. Similarly, conversations 36, Wikiboards 84 or file sharing 138 may be initiated and generated in association with the teaching content 24. Learners 14 can easily link their conversations 36 to the teaching content 24 using a single click bookmark function. For this purpose, the display device further displays a bookmark icon 144 to link learner-initiated content 36 to teaching content 24 displayed adjacent to the said learner-initiated content 26 by selecting the bookmark icon 144. Related conversations 36 bookmarked to teaching content 24 are listed to allow track-back referencing. A track-back icon 142 associated with the teaching content 24 allows the user to automatically list related learner-initiated content 26 such as blogs 34 or conversations 36.

When new user-initiated content 26 is created, the bookmark icon 144 allows the user to link such user-initiated content 26 (in this case, a blog 34) to the teaching content 24 to the left with one click. At the same time, a track-back link is formed from the item of teaching content 24 back to the item of user-initiated content 26. Later, if the same item of teaching content 24 is accessed by the same user or another user, the track-back icon 142 allows the later user to access all related learner-initiated content 26. The bookmark icon 144 may further be programmed such that, where teaching content 24 has not been selected, clicking on the bookmark icon 144 causes the system to load the relevant teaching content in the main window.

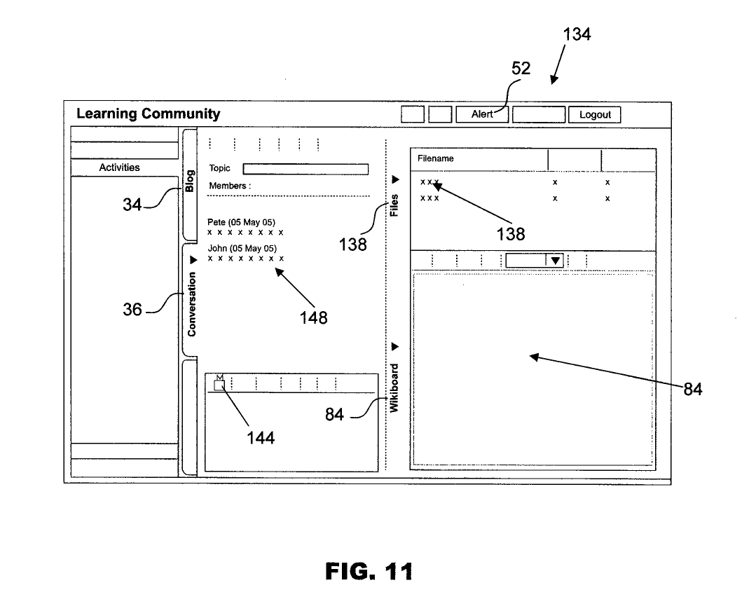

FIG. 11 is an exemplary screenshot illustrating collaborative writing (Wikiboard 84) and file sharing 138 spaces made available under a conversation module 36 according to the preferred embodiment of the invention. Each conversation item has associated spaces for file sharing 138 and a Wikiboard 84 to facilitate collaboration. The file-sharing spaces 138 associated with the conversation tool allow users 20 to insert file attachments relating to a conversation 36. A chat portion 148 of the conversation module 36 allows learners to discuss their ongoing collaboration on the Wikiboard 84 and in the file-sharing 138 spaces. The bookmark icon 144 allows the user to link these related components to an item of teaching content 24 that is being accessed.

The invention described herein is susceptible to variations, modifications and/or additions other than those specifically described and it is to be understood that the invention includes all such variations, modifications and/or additions which fall within the spirit and scope of the above description. Accordingly, the drawings and description herein are to be regarded as illustrative in nature and not in a restrictive or limiting sense.

1. A learner-centered system for collaborative learning that is accessible by a community of users over an electronic communications network, comprising:
a data storage device for storing data comprising items of teaching content and learner-initiated content;
a set of collaborative dialogue tools configured for learners to freely initiate and generate their own items of learner-initiated content in relation to items of teaching content for storage; and
a linking mechanism operative to enable learners to generate one or more links between an item of learner-initiated content so stored and at least one item of teaching content.

2. The system as claimed in claim 1, wherein the links comprise bidirectional links, such that each bidirectional link comprises a primary link from an item of learner-initiated content to an item of teaching content and a reverse link in an opposite direction.

3. The system as claimed in claim 2, including a track-back function selectable by way of a track-back icon for accessing corresponding bidirectionally-linked items of associated teaching content and learner-initiated content that have been linked.

4. The system as claimed in claim 1, including a navigation interface that is configured to list items of learner-initiated content created by the dialogue tools, wherein the list of items is sortable to facilitate searching.

5. The system as claimed in claim 1, including a display device that is configured to display teaching content and learner-initiated content adjacent to each other, and the display device further displays an icon operative to allow learners to link learner-initiated content to teaching content displayed adjacent to said learner-initiated content by selecting the icon.

6. The system as claimed in claim 1, wherein the dialogue tools comprise a conversation tool and a web-based publication tool.

7. The system as claimed in claim 6, wherein the conversation tool further comprises a collaborative writing tool.

8. The system as claimed in claim 6, wherein the conversation tool is configured to allow learners to select any other member of the community to participate in an online conversation.

9. The system as claimed in claim 8, wherein the conversation tool includes a pre-programmed status indicator to indicate which learner has accessed the latest conversation update.

10. The system as claimed in claim 6, including a file-sharing space associated with the conversation tool for inserting file attachments relating to a conversation.

11. The system as claimed in claim 6, wherein the web-based publication tool is operative to receive and store comments made by other users to an entry made using the tool.

12. The system as claimed in claim 11, wherein all entries made using the web-based publication tool and comments thereon are made accessible for viewing by all members of the same community.

13. The system as claimed in claim 6, wherein the dialogue tool further comprises a personal workspace for storing learners' entries, and such entries are configured to be exportable to create personal online portfolios of learners.

14. The system as claimed in claim 6, wherein the system is configured to store conversation transcripts for retrieval such that participants to a conversation who are not online when an entry is posted to a conversation transcript may read the entry and add to the conversation transcript when they are online.

15. The system as claimed in claim 6, including a customizable alert module for alerting a user as to the entry of a new item of learner-initiated content.

16. A server computer comprising the system as claimed in claim 1.

17. A learner-centered method for collaborative learning, comprising the steps of:
providing a data storage device for storing data comprising items of teaching content and learner-initiated content, and configuring the data storage device such that said data is accessible by a community of users over an electronic communications network;
enabling learners to freely initiate and generate their own items of learner-initiated content in relation to items of teaching content for storage; and
generating one or more links between an item of learner-initiated content so stored and at least one item of teaching content at the option of the learners.
